(19) United States
(12) Patent Application Publication
(10) Pub. No.: US 2005/0048348 A1
(43) Pub. Date: Mar. 3, 2005

(54) Fuel cell system and bracket therefor

(75) Inventor: Ricardo Bazzarella, Cambridge (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/926,106

(22) Filed: Aug. 26, 2004

Related U.S. Application Data
(60) Provisional application No. 60/525,887, filed on Dec. 1, 2003.
(60) Provisional application No. 60/497,568, filed on Aug. 26, 2003.

(51) Int. Cl. H01M 2/10; H01M 8/24; F16M 11/00

(52) U.S. Cl. 429/34; 248/200

(57) ABSTRACT

A bracket for a fuel cell system having at least one fuel cell stack and a number of peripheral devices is disclosed. The bracket includes first and second spaced apart side frames joined to each other by one or more end frames. The first side frame and the second side frame surround a portion of one or more fuel cell stacks. The fuel cell stack is removably mounted between the first and second side frames, and the peripheral devices are removably mounted to an outside face of the side frames. A fuel cell system is also disclosed. The fuel cell system includes one or more fuel cell stacks and one or more peripheral devices. The fuel cell stacks and the peripheral devices are removably mounted to a bracket, as described above.

### FIELD OF THE INVENTION

This invention relates to a main bracket for a fuel cell system, and more particularly relates to a main bracket for mounting a fuel cell stack, as well as peripheral devices, and piping for fuel cell stacks.

### BACKGROUND OF THE INVENTION

Fuel cells have been proposed as a clean, efficient and environmentally friendly source of power which can be utilized for various applications. A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode, i.e. anode where it reacts electrochemically in the presence of the electrolyte to produce electrons and cations. The electrons are conducted from the anode to a second electrode, i.e. cathode through an electrical circuit connected between the electrodes. Cations pass through the electrolyte to the cathode. Simultaneously, an oxidant, such as oxygen gas or air is introduced to the cathode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The anode may alternatively be referred to as a fuel or oxidizing electrode, and the cathode may alternatively be referred to as an oxidant or reducing electrode. The half-cell reactions at the two electrodes are, respectively, as follows:
H₂→2H⁺+2e⁻
½O₂+2H⁺+2e⁻→H₂O

The external electrical circuit withdraws electrical current and thus receives electrical power from the fuel cell. The overall fuel cell reaction produces electrical energy as shown by the sum of the separate half-cell reactions written above. Water and heat are typical by-products of the reaction. Accordingly, the use of fuel cells in power generation offers potential environmental benefits compared with power generation from combustion of fossil fuels or by nuclear activity. Some examples of applications are distributed residential power generation and automotive power systems to reduce emission levels.

In practice, fuel cells are not operated as single units. Rather fuel cells are connected in series, stacked one on top of the other, or placed side-by-side, to form what is usually referred to as a fuel cell stack. The fuel, oxidant and coolant are supplied through delivery subsystems to the fuel cell stack. Also within the stack are current collectors, cell-to-cell seals and insulation, with required piping and instrumentation provided externally to the fuel cell stack.

Fuel cell stacks have been used as power sources in various applications, such as fuel cell powered electric vehicles, residential power generators, auxiliary power units, uninterrupted power sources, etc. For fuel cell stacks to be used in power generation applications, many peripheral devices, conditioning devices are needed since fuel cell stacks rely on peripheral preconditioning devices for optimum or even proper operation. Extensive piping and plumbing work is also required for connection between such devices.

For example, in the situation where the fuel gas of the fuel cell stack is not pure hydrogen, but rather hydrogen containing material (e.g. natural gas), a reformer is usually required in the fuel delivery subsystem for reforming the hydrogen containing material to provide pure hydrogen to the fuel cell stack. Moreover, in the situation where the electrolyte of the fuel cell is a proton exchange membrane, since most of the membranes currently available requires a wet surface to facilitate the conduction of protons from the anode to the cathode, and otherwise to maintain the membranes electrically conductive, a humidifier is usually required to humidify the fuel or oxidant gas before it comes into the fuel cell stack. In addition, most conventional fuel cell systems utilize several heat exchangers in gas and coolant delivery subsystems to dissipate the heat generated in the fuel cell reaction, provide coolant to the fuel cell stack, and heat or cool the process gases. In some applications, the process gases or coolant may need to be pressurized before entering the fuel cell stack, and/therefore, compressors and pumps may be added to the delivery subsystems. These peripheral devices are usually referred to, collectively, as the “Balance of Plant” (BOP), and this term encompasses any peripheral device necessary for the operation of a particular fuel cell stack configuration.

These peripheral devices as well as the fuel cell stacks are often packaged together as a power module, which will often be located in a confined environment where space is limited, such as vehicular applications or other portable applications. Usually, extensive mounting fixtures are required. In a conventional fuel cell system, in order to construct a compact power module, peripheral devices are usually mounted one on the other or several devices are mounted on one large device, such as the fuel cell stack. However, this method of constructing a power module poses a number of problems. First, when maintenance or replacement of any component (such as the fuel cell stack) is required, other components that are mounted onto this component have to be unbolted, which often requires further disassembly of associated components (such as one or more of the peripheral devices). After the maintenance of replacement is completed, the power module has to be reassembled, which requires no less labor or time than assembling a new power module. Moreover, the mounting relations between the components in a power module could negatively affect the performance of other components. In vehicular or portable applications, the power module is often moving. Vibration, trembling or shaking may cause displacement of components. In conventional systems, displacement of one component directly affects the other components. This renders the conventional systems inflexible and vulnerable to unfavorable operation environments.

Therefore, there is a need for a power module that is easier to assemble, maintain and has improved flexibility for vibration and other unfavorable conditions.

### SUMMARY OF THE INVENTION

According to a first aspect of the present invention, a bracket for a fuel cell system having at least one fuel cell stack and a plurality of peripheral devices is provided. The bracket comprises: a) a first side frame; and b) a second side frame spaced apart from the first side frame and operatively connected to the first side frame. The first side frame and the second side frame surround at least a portion of the at least one fuel cell stack. The first and second side frames are adapted for removably mounting the at least one fuel cell stack between the first and second side frames. The first and second side frames are adapted for removably mounting the plurality of peripheral devices to any face of one or more of the first side frame and the second side frame. Preferably, the peripheral devices are mounted to the outside face of one or both side frames.

According to a second aspect of the invention, an electrochemical cell system is provided. The electrochemical cell system comprises: a) at least one fuel cell stack; b) a plurality of peripheral devices operatively connected to the at least one fuel cell stack; and c) a bracket surrounding at least a portion of the at least one fuel cell stack. The bracket is adapted for removably mounting the at least one fuel cell stack therein. The bracket is adapted for removably mounting the plurality of peripheral devices to an outside face thereof.

The fuel cell system and bracket according to the present invention facilitates the removal of one or more fuel cell stacks for repair and the like, while reducing the need to disassemble the peripheral devices which form part of the fuel cell system.

### BRIEF DESCRIPTION OF THE DRAWINGS

For a better understanding of the present invention, and to show more clearly how it may be carried into effect, reference will now be made to the accompanying drawings, which show, by way of example, preferred embodiments of the present invention. The features and advantages of the present invention will become more apparent in light of the following detailed description of preferred embodiments thereof.

FIG. 1a is a perspective view illustrating a fuel cell system having a first embodiment of a main bracket according to the present invention;

FIG. 1b is a side elevational view illustrating the fuel cell system having the first embodiment of the main bracket according to the present invention;

FIG. 1c is a top view illustrating the fuel cell system having the first embodiment of the main bracket according to the present invention;

FIG. 1d is a first end elevational view illustrating the fuel cell system having the first embodiment of the main bracket according to the present invention;

FIG. 1e is a second side elevational view illustrating the fuel cell system having the first embodiment of the main bracket according to the present invention;

FIG. 1f is a second end elevational view illustrating the fuel cell system having the first embodiment of the main bracket according to the present invention;

FIG. 1g is a bottom view illustrating the fuel cell system having the first embodiment of the main bracket according to the present invention;

FIG. 2a is a perspective view illustrating the first embodiment of the main bracket according to the present invention;

FIG. 2b is a side elevational view illustrating the first embodiment of the main bracket according to the present invention;

FIG. 2c is a first end view illustrating the first embodiment of the main bracket according to the present invention;

FIG. 2d is a second end view illustrating the first embodiment of the main bracket according to the present invention;

FIG. 3a is a perspective view illustrating a side frame of the first embodiment of the main bracket according to the present invention;

FIG. 3b is a side view illustrating the side frame of the first embodiment of the main bracket according to the present invention;

FIG. 3c is a top view illustrating the side frame of the first embodiment of the main bracket according to the present invention;

FIG. 3d is a front elevational view illustrating the side frame of the first embodiment of the main bracket according to the present invention;

FIG. 4a is a first perspective view illustrating a first end frame of the first embodiment of the main bracket according to the present invention;

FIG. 4b is a second perspective view illustrating the first end frame of the first embodiment of the main bracket according to the present invention;

FIG. 5a is a perspective view illustrating a second end frame of the first embodiment of the main bracket according to the present invention;

FIG. 5b is a front elevational view illustrating the second end frame of the first embodiment of the main bracket according to the present invention;

FIG. 5c is a side view illustrating the second end frame of the first embodiment of the main bracket according to the present invention;

FIG. 5d is a top view illustrating the second end frame of the first embodiment of the main bracket according to the present invention;

FIG. 6a is a first perspective view illustrating a second embodiment of the main bracket according to the present invention;

FIG. 6b is a second perspective view illustrating the second embodiment of the main bracket according to the present invention;

FIG. 7 is a perspective view illustrating a first end frame of the second embodiment of the main bracket according to the present invention;

FIG. 8a is a perspective view illustrating a second end frame of the second embodiment of the main bracket according to the present invention;

FIG. 8b is a side view illustrating the second end frame of the second embodiment of the main bracket according to the present invention;

FIG. 8c is a front elevational view illustrating the second end frame of the second embodiment of the main bracket according to the present invention;

FIG. 9a is a first perspective view illustrating a side frame of the second embodiment of the main bracket according to the present invention;

FIG. 9b is a second perspective view illustrating the side frame of the second embodiment of the main bracket according to the present invention;

FIG. 9c is a side view illustrating the side frame of the second embodiment of the main bracket according to the present invention;

FIG. 10a is a perspective view illustrating a fuel cell system having a third embodiment of the main bracket according to the present invention;

FIG. 10b is a top view illustrating the fuel cell system having the third embodiment of the main bracket according to the present invention;

FIG. 11 is a perspective view illustrating a fuel cell system having a fourth embodiment of the main bracket according to the present invention;

FIG. 12a is a first perspective view illustrating a fuel cell system having a fifth embodiment of the main bracket according to the present invention;

FIG. 12b is a second perspective view illustrating the fuel cell system having the fifth embodiment of the main bracket according to the present invention;

FIG. 12c is a third perspective view illustrating the fuel cell system having the fifth embodiment of the main bracket according to the present invention;

FIG. 13 is a perspective view illustrating a fuel cell system having a sixth embodiment of the main bracket according to the present invention;

FIG. 14a is a perspective view illustrating a fuel cell system having a seventh embodiment of the main bracket according to the present invention;

FIG. 14b is a side view illustrating the fuel cell system having the seventh embodiment of the main bracket according to the present invention;

FIG. 14c is a front elevational view illustrating the fuel cell system having the seventh embodiment of the main bracket according to the present invention;

FIG. 14d is a top view illustrating the fuel cell system having the seventh embodiment of the main bracket according to the present invention;

FIG. 15a is a perspective view illustrating the seventh embodiment of the main bracket according to the present invention;

FIG. 15b is a front elevational view illustrating the seventh embodiment of the main bracket according to the present invention;

FIG. 15c is a top view illustrating the seventh embodiment of the main bracket according to the present invention;

FIG. 15d is a side view illustrating the seventh embodiment of the main bracket according to the present invention;

FIG. 16a is a first perspective view illustrating a conventional fuel cell system; and

FIG. 16b is a second perspective view illustrating the conventional fuel cell system.

### DETAILED DESCRIPTION OF THE INVENTION

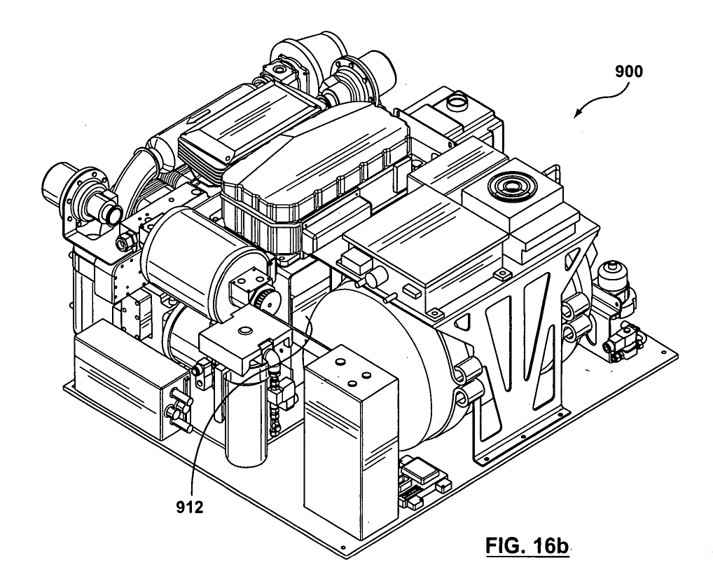

FIGS. 16a and 16b show a conventional fuel cell system 900, where peripheral devices are mounted on a fuel cell stack 912. The fuel cell system 900 has the disadvantages described above.

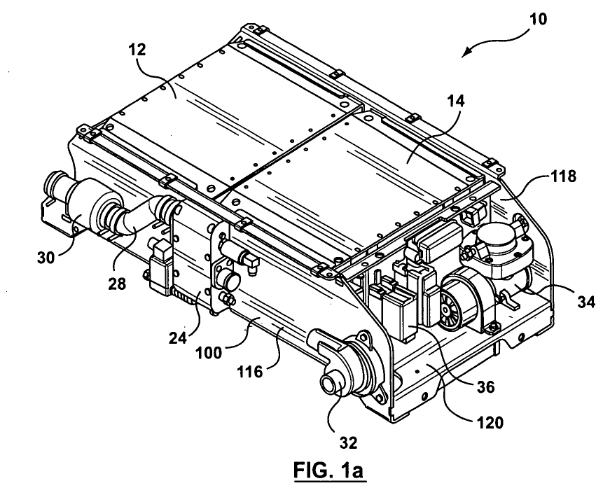

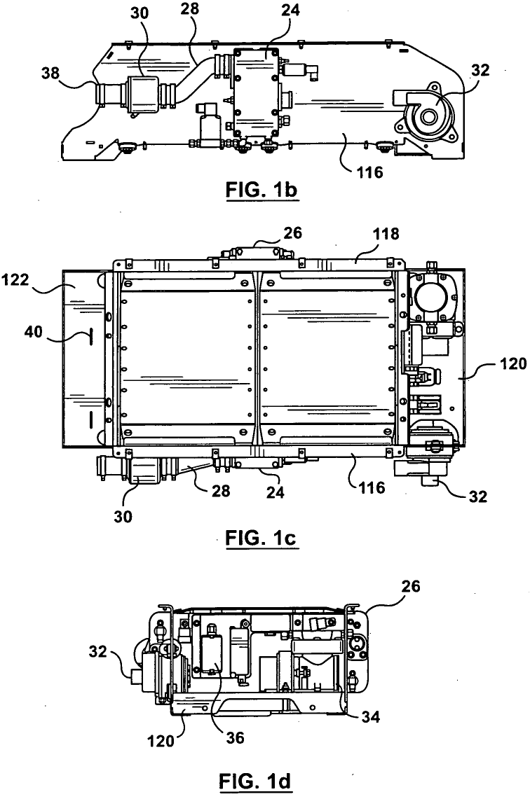

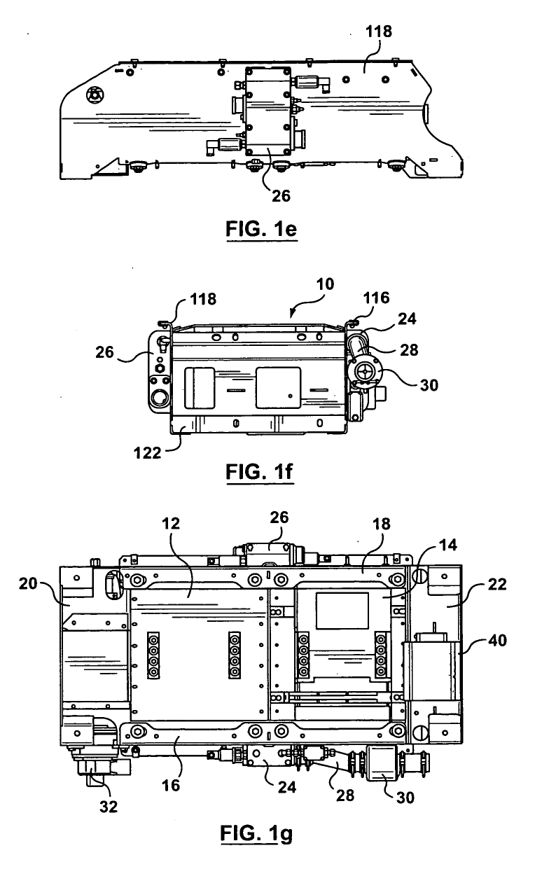

FIGS. 1a to 1g show a fuel cell system 10 having a first embodiment of the main bracket 100 according to the present invention. It is to be appreciated that the fuel cell system 10 can be of any configuration and the fuel cell stacks can comprise any type of fuel cells, such as Proton Exchange Membrane (PEM) fuel cells, solid oxide fuel cells, alkaline fuel cells, etc. The peripheral components of the fuel cell system and types of fuel cells do not form part of the present invention. Examples of fuel cell system were disclosed in the applicant's co-pending U.S. patent application Ser. Nos. 10/122,125, 10/122,137, the entirety of which is incorporated herein by reference. The applicant's co-pendng US patent application entitled “Apparatus for Removably Attaching an Electrochemical Cell Stack to Its Operating System” filed on Aug. 26, 2004 Ser. No. ______ (serial number not yet assigned) is also incorporated by reference herein. It will also be understood by those skilled in the art that the bracket and system of the present invention may include any electrochemical cell system, including without limitation electrolysers.

The fuel cell system 10 in FIGS. 1a to 1g has two fuel cell stacks 12 and 14. The main bracket 100 has first and second side frames 116, 118, respectively, joined together by first and second end frames 120, 122. The first and second side frames 116, 118 and first and second end frames 120, 122 enclose the two fuel cell stacks 12 and 14 and support various peripheral devices. Specifically, a first manifold 24 is mounted on the outside face of the first side frame 116 and a second manifold 26 is mounted on the outside face of the second side frames 118, for supplying process fluids, such as fuel, oxidant and coolant to the fuel cell stacks 12, 14 and directing unreacted fluids out of the fuel cell stacks 12, 14. Preferably, the first and second manifolds 24, 26 are siamese manifolds which connect to both fuel cell stacks 12, 14. A tube 28 is connected to the first manifold 24 for delivering a process fluid and a water separator 30 is connected to the tube 28 for separating liquid water from the process fluid. Another tube 38 is connected to the water separator 30 for directing the process fluid. As best shown in FIGS. 1a and 1b, the tubes 28 and 38 are not mounted directly onto the main bracket 100, but rather to peripheral devices. However, the tubes 28, 38 may be attached to the first side frame 116. The tubes 28, 38 extend substantially along the longitudinal direction of the first side frame 116 and adjacent to the first side frame 116.

Referring now to FIGS. 1a to 1c, a coolant pump 32 passes through a through hole near one end of the first side frame 116 and is mounted thereon. Although no tubes or other connections are shown, it can be appreciated that the coolant pump 32 supplies the coolant to the manifold 24 or 26 and then to the fuel cell stacks 12, 14. A fuel recirculation pump 34 is mounted on the first end frame 120 of the main bracket 100. Likewise, although no fluid connection is shown, it can be understood that the fuel recirculation pump 34 recirculates fuel from the anode exhaust of the fuel cell stacks 12, 14 back to the anode inlet thereof, as described in of the aforementioned US patent applications. Hence, it can be understood that the fuel recirculation pump 34 is in fluid communication with either one or both of the first and second manifolds 24 and 26.

An electrical controlling unit 36 is mounted on the first end frame 120. It serves to control the operation of various peripheral devices. A fuel cell voltage monitoring unit 40 is mounted on the second end frame 122 located at the end of the two side frames 116, 118 opposite to the first end frame 120. This fuel cell voltage monitoring unit 40 monitors the voltages of the fuel cells within the fuel cell stacks 12, 14 and may be in electrical connection with the electrical control unit (ECU) 36 or other analysis devices external to the fuel cell system 10.

FIGS. 1a to 1g are only intended to schematically show one exemplary configuration for a fuel cell system with typical peripheral devices. It will be understood by those skilled in the art that many fuel system configurations utilizing a wide variety of peripheral devices are possible, and that any configuration of peripheral devices or balance of plant, mounted in a bracket in combination with one or more fuel cell stacks is within the scope of the present invention.

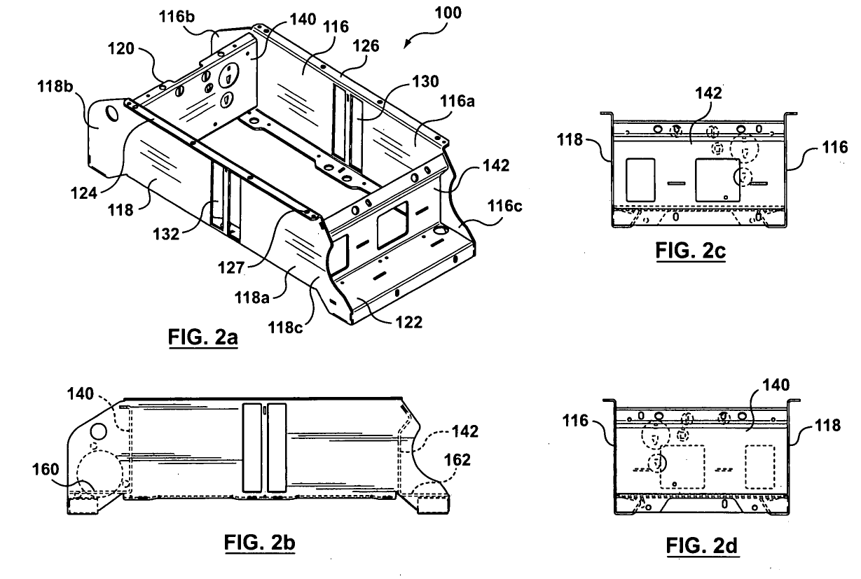

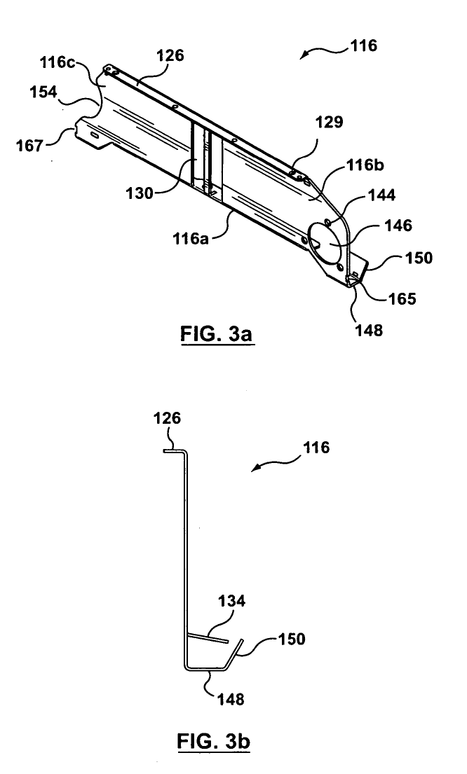

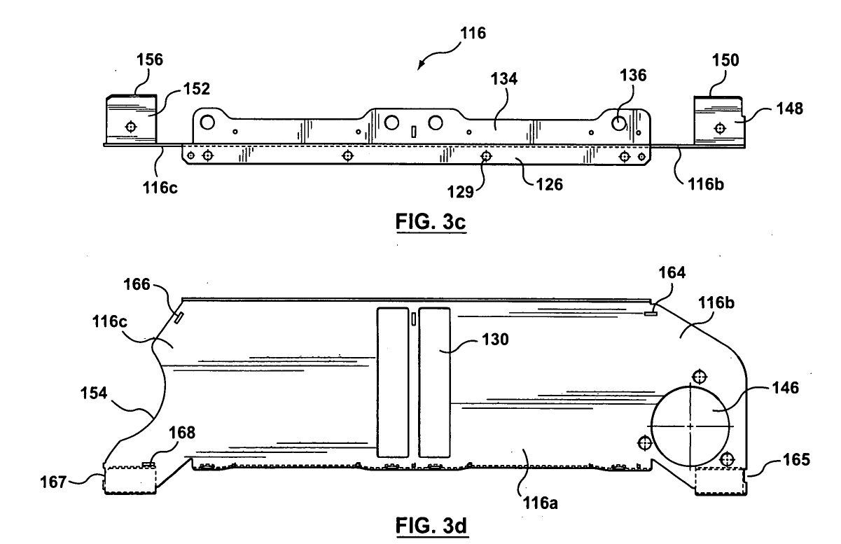

FIGS. 2a to 2d show the first embodiment of the main bracket 100 according to the present invention, with no peripheral devices mounted thereon. FIGS. 3a to 5c show detailed structure of individual frames 116, 118, 120, 122 of the main bracket 100. Now the structure of the main bracket 100 and its frames will be described in detail in one exemplary operating position. Hence, the words “top”, “bottom”, etc should be construed in accordance with the operating position of the fuel cell system. However, it will be understood by those skilled in the art that the main bracket 100 can operate in any orientation. The side and end frames may be made of sheet or plate shaped metal or other material, such as plastics. Each of the two spaced apart side frames 116, 118 has a generally elongate shape with each end frame 120, 122 connecting the side frames 116, 118 near their two ends. The first side frame 116 includes a central portion 116a located between a vertical portion 140 of the first end frame 120 and a vertical portion 142 of the second end frame 122. The first side frame 116 also includes two end portion 116b and 116c outside of the vertical portion 140 and 142, respectively.

In this embodiment, as shown in FIGS. 1a to 1g, the main bracket 100 encloses the sides of the two fuel cell stacks 12, 14. The preferably planar side frames 116 and 118 are placed vertically during operation. Each side frame has a manifold 24, 26 mounted on the outside face thereof. As best shown in FIG. 2a, at least one slot 132 is provided in the second side frame 118 and similarly at least one slot 130 is provided in the second side frame 116. As an example, a first pair of slots 130 and a second pair of slots 132 are shown in this embodiment. The pairs of slots 130 and 132 in the side frames 116 and 118, respectively allow the manifolds 24 and 26 to pass through and mount on the fuel cell stacks 12 and 14. The manifolds 24 and 26 may also be configured to mount on the side frames 116 and 118. In such a variant, through holes need to be provided on the side frames 116 and 118. The first and second pair of slots 130 and 132 are provided generally in the center of the central portion 116a, 118a in order to contract the two fuel cell stacks 12 and 14, which have similar dimensions.

Continuing to refer to FIGS. 3a to 3d, the top end of the central portion 116a of the first side frame 116 is bent to form a top flange 126. The bottom end of the central portion 116a of the first side frame 116 is also bent to a bottom flange 134. Both the top and bottom flanges 126 and 134 extend along the longitudinal extent of the central portion 116a of the first side frame 116. A plurality of through holes 129 are provided in the top flange 126 and a plurality of through holes 136 are provided in the bottom flange 134. The top flange 126 may be used to secure a cover on top of the fuel cell stacks 12 and 14. However, the cover is not essential and hence not shown in this embodiment. The bottom flange 134 supports the fuel cell stacks 12 and 14 when the fuel cell system 10 is assembled. The through holes 136 accommodate screws and bolts to secure the fuel cell stacks 12 and 14 on the bottom flange 134. The shapes of end portions 116b, 116c of the side frame 116 depend on the configuration of the components in the fuel cell system 10. Through holes 144 can be provided in the end portions to fixing peripheral devices on the frame. In this embodiment, a through hole 146 is provided in the end portion 116b to accommodate the coolant pump shown in FIGS. 1a to 1g. A concave portion 154 is provided in the end portion 116c to allow components or peripheral devices of fuel cell system 10 to protrude out of the side frame 116. The bottom of the end portion 116b has an inwardly bent portion 148 and then an upward extension 150. Similarly, the bottom of the end portion 116c has an inwardly bent portion 152 and then an upwardly extension 156. The upward extensions 150 and 156 support the horizontal portion 160 of the first end frame 120 and the horizontal portion 162 of the second end frame 122, respectively. A mounting slot 164 is provided near the top end of the end portion 116b for accommodating a tenon of the end frame 120 to form a tenon joint. A notch 165 is provided near the bottom end of the end portion 116b, through which a tenon of the end frame 120 can be inserted to form a tenon joint. Likewise, a mounting slot 166 is provided near the top end of the end portion 116c, a mounting slot 168 is provided near the bottom end of the end portion 116c and a notch 167 is provided at the end of the end portion 116c for accommodating tenons of the end portion 122. As shown in FIGS. 3a to 3d, mounting slots can also be provided in the central portion 116a and even the bottom flange 134 for attaching devices to the side frame 116a. However, the number and position of these mounting slots depend on the configuration of the fuel cell system.

The detailed structure of the second side frame 118 is generally symmetrical to the first side frame 116 except that the actual position of through holes and/or mounting slots may be different. Accordingly, the second side frame 118 will not be further described. As mentioned above, the position of through holes is dependent on the specific configuration of the fuel cell system.

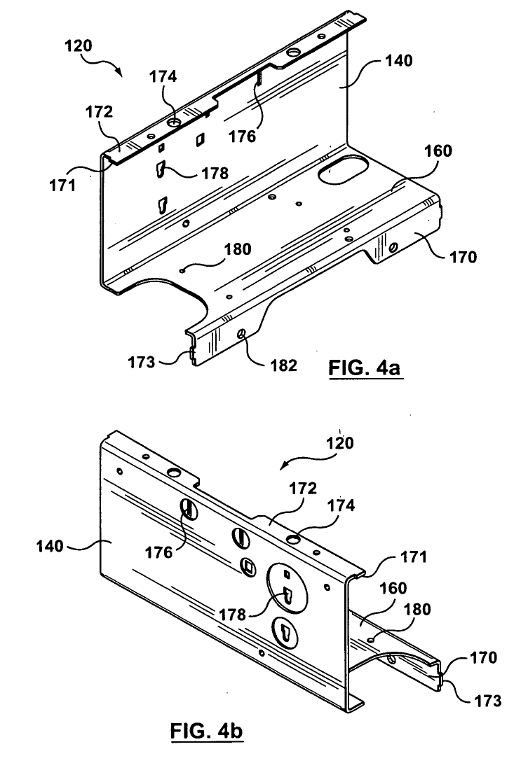

Referring to FIGS. 4a and 4b, the first end frame 120 has a vertical portion 140 and a horizontal portion 160. The vertical portion 140 is provided with a plurality of mounting slots 176 and 178. Similarly, the horizontal portion 160 is provided with a plurality of through holes 180 for mounting peripheral devices using fasteners, such as screws of bolts. Some portions in the horizontal portion 160 are cut out to allow parts of the peripheral devices to pass through. The top end of the vertical portion 140 is bent to form a flange 172. Through holes 174 are provided for mounting the aforementioned cover. The end of the horizontal portion 160 is also bent to form a flange 170. Through holes 182 are provided for mounting peripheral devices or mounting the main bracket 100 to its intended location, such as a vehicle chassis. At each end of the flange 172, a tenon 171 is provided for inserting into the mounting slot 164 on the first side frame 116 and corresponding mounting slot on the second side frame 118, thereby forming a tenon joint. Likewise, at each end of the flange 170, a tenon 173 is provided for inserting into the notch 165 on the side frame 116 and corresponding notch on the side frame 118. Hence, the end frame 120 is removably assembled with the two side frames 116 and 118. The end frame 120 is also made of sheet or plate shaped materials. The vertical portion 140 and the horizontal portion 160 are preferably integrally constructed from one sheet. Alternatively, they can be made from two or more sheets.

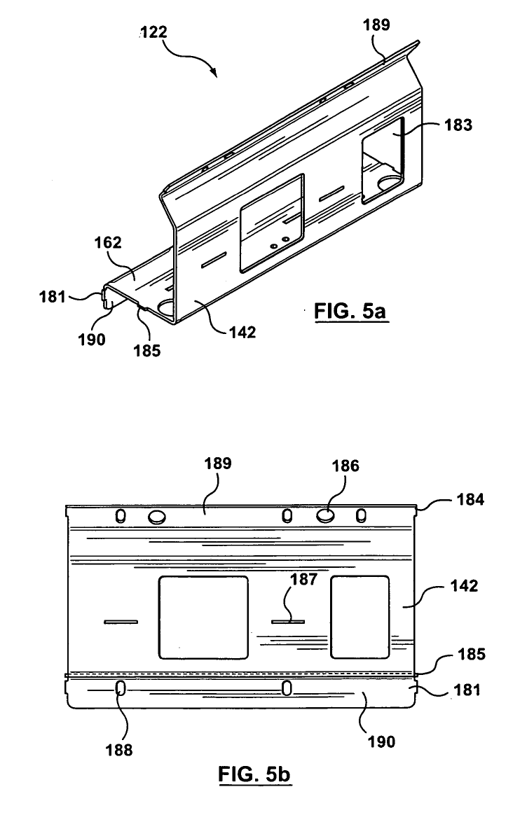

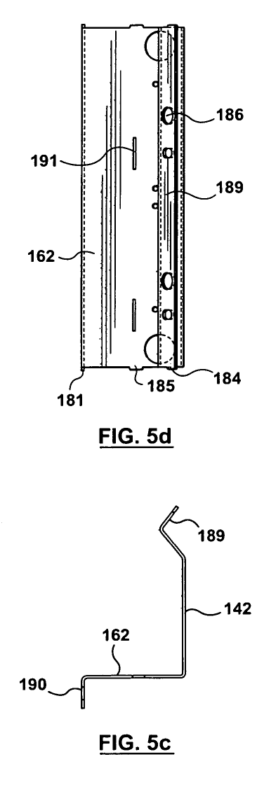

Referring now to FIGS. 5a to 5b, the second end frame 122 also has a vertical portion 142 and a horizontal portion 162, preferably constructed from one piece of sheet metal or plate shaped material. The top end of the vertical portion 142 is bent to form a flange 189 with a plurality of through holes provided 186 thereon for mounting the aforementioned cover. In this particular embodiment, the flange 189 is inclined instead of horizontal (as for the first end frame 120). It will be understood that the inclined position of flange 189 is not essential and depends on actual configuration of the fuel cell system. Cutout portions 183 are provided on the vertical portion 142 to allow peripheral devices to pass through in order to connect to the fuel cell stacks 12 and 14. Mounting slots 187 are provided on the vertical portion 142 for mounting peripheral devices on the second end frame 122. The end of the horizontal portion 162 is bent to form a flange 190. Through holes 188 are provided in the flange 190 for mounting peripheral devices or mounting the main bracket 100 to its intended location, such as a vehicle chassis. Cutout portions and mounting slots 191 can be provided in the horizontal portion 162. At each end of the flange 189, a tenon 184 is provided for inserting into the mounting slot 166 of the first side frame 116 and the corresponding mounting slot of the second side frame 118. At each end of the flange 190, a tenon 181 is provided for inserting into the notch 167 of the first side frame 116 and the corresponding notch of the second side frame 118. Likewise, each end of the horizontal portion 162 is provided with a tenon 185 for inserting into the mounting slot 168 and the corresponding mounting slot in the side frame 118. In this way, the end frame 122 is assembled with side frames 116 and 118.

As can be seen in FIGS. 1a to 5d, the first and second side frames 116, 118 and the end frames 120, 122 enclose a generally rectangular bracket 100. Fuel cell stacks 12 and 14 are mounted inside of the bracket 100 which surrounds the sides of the fuel stacks 12, 14. The various peripheral devices discussed above and illustrated in FIGS. 1a-g are mounted around the outside of the bracket 100.

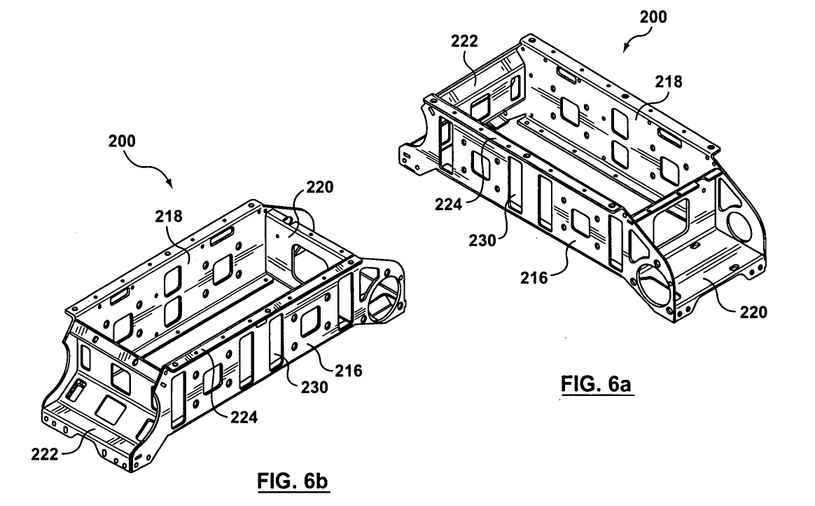

FIGS. 6a and 6b show a second embodiment of the main bracket 200 according to the present invention. The second embodiment of the main bracket 200 is also generally rectangular in shape and comprises of first and second side frames 216, 218 and first and second end frames 220, 222. The side frames and end frames are also made of sheet-shaped or other planar materials. Preferably, a pair of slots 230 are provided in first side frame 216 to receive the manifold, as described for the first embodiment above.

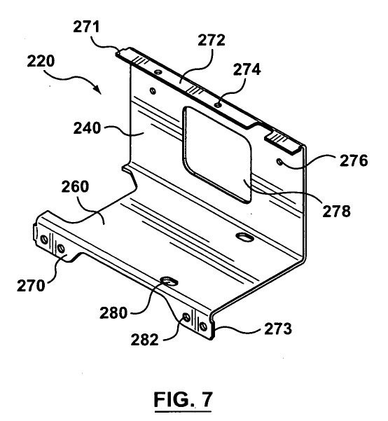

Referring to FIG. 7, the first end frame 220 of main bracket 200 has a vertical portion 240 and a horizontal portion 260. The top end of the vertical portion 240 is bent to form a flange 272. The end of the horizontal portion 260 is bent to form a flange 270. Through holes 274 are provided in the flange 272 for mounting a cover (not shown) of the fuel cell system. The flange 270 also includes through holes 282 for mounting peripheral devices or mounting the main bracket to where it is intended to mount, such as a vehicle chassis. Each end of the flange 270 is provided with a mounting slot 273 and each end of the flange 272 is provided with a tenon 271. Through holes 276 are 280 are respectively provided in the vertical portion 242 and the horizontal portion 280 for mounting peripheral devices. A cutout portion 278 is also provided in the vertical portion 240 to allow a peripheral device to pass through for connection to the portion of fuel cell stacks (not shown) that are surrounded by the main bracket 200.

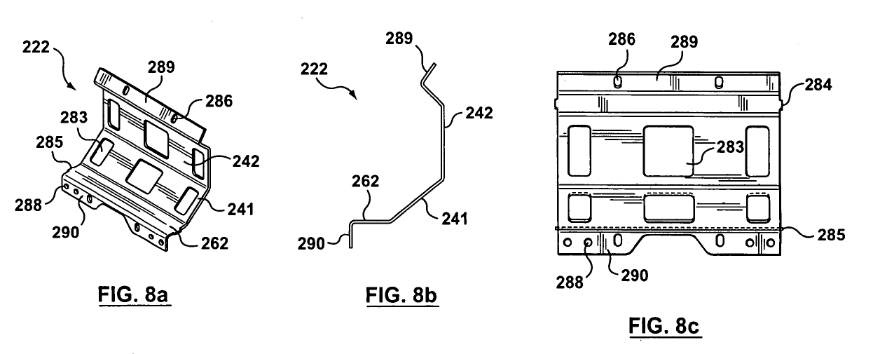

Referring now to FIGS. 8a to 8c, the second end frame 222 generally has a vertical portion 242, a horizontal portion 262 and an inclined portion 241 connecting the vertical portion 242 and the horizontal portion 262. The vertical portion 242, the horizontal portion 262 and the inclined portion 241 are integrally constructed from a single sheet of material. Alternatively, they can be made from separate pieces and joined together. A plurality of cutout portions 283 are provided in the vertical portion 242 and the inclined portion 241 to allow fuel cell peripheral devices to pass through the second end frame 222 and connect to the fuel cell stack. The top of the vertical portion 242 is bent to form a flange 289 with a plurality of through holes 286 provided thereon for mounting the aforementioned cover. The end of the horizontal portion 262 is bent to form a flange 290 with a plurality of through holes 288 provided thereon for mounting peripheral devices or mounting the main bracket to its intended location, such as a vehicle chassis. Each end of the vertical portion is provided with a tenon 284 and each end of the horizontal portion 262 is provided with a tenon 285.

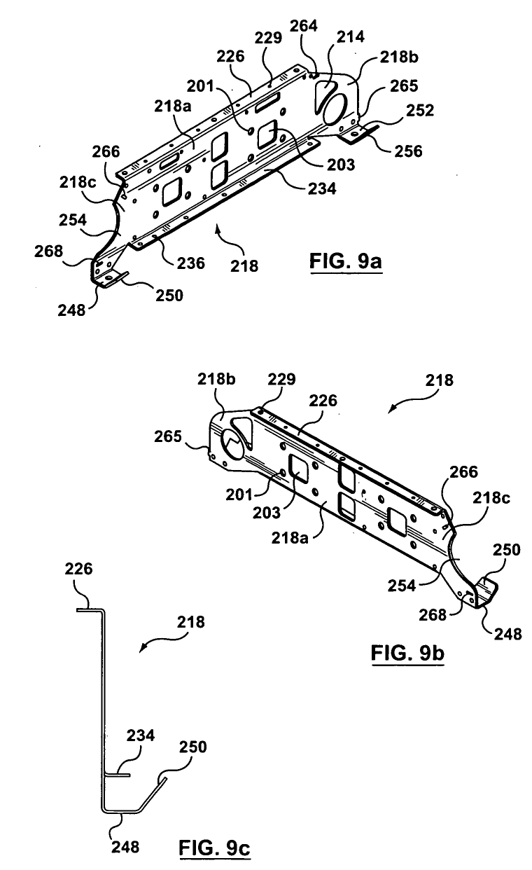

Referring to FIGS. 9a to 9c, together, the second side frame 218 includes a central portion 218a (located between end frames 220, 222) and two end portions 218b and 218c (located outside end frames 220, 222). The top end of the central portion 218a of the second side frame 218 is bent to form a top flange 226. The bottom end of the central portion 218a of the side frame 218 is also bent to a bottom flange 234. Both the top and bottom flanges 226 and 234 extend along the longitudinal extent of the central portion 218a of the side frame 218. A plurality of through holes 229 are provided in the top flange 226 and a plurality of through holes 236 are provided in the bottom flange 234. The top flange 226 is used to secure a cover (not shown) on top of the fuel cell stacks (not shown). The bottom flange 234 supports the fuel cell stacks when the fuel cell system is assembled. The through holes 236 accommodate fasteners, such as screws and bolts to secure the fuel cell stacks to the bottom flange 234. The configuration of end portions 218b, 218c of the side frame 218 depend on the configuration of the components in the fuel cell system. Through holes 214 can be provided in the end portion 218b to mount peripheral devices on the side frame 218 and to position the peripheral devices as desired. A concave portion 254 is provided in the end portion 218c to allow components of the fuel cell system to protrude out of the second side frame 218. The bottom of the end portion 218b has an inwardly bent portion 252 and then an upward extension 256. Similarly, the bottom of the end portion 218c has an inwardly bent portion 248 and then an upward extension 250. The upward extensions 250 and 256 support the horizontal portion 260 of the end frame 220 and the horizontal portion 262 of the end frame 222, respectively. A mounting slot 264 is provided near the top end of the end portion 218b for accommodating the tenon 271 of the end frame 220 to form a tenon joint. A tenon 265 is provided near the bottom end of the end portion 218b for inserting into the mounting slot 273 of end frame 220 to form a tenon joint. Likewise, a mounting slot 266 is provided near the top end of the end portion 218c, and a mounting slot 268 is provided near the bottom end of the end portion 218c for respectively accommodating tenons 284, 285 of the end frame 222. The central portion 218a can be provided with a plurality of through holes 201 for mounting peripheral devices onto the side frame 218 and cutout portions 203 to allow connection between the fuel cell stacks and the peripherals. The exact number and position of these through holes and cutout portions depend on the configuration of the fuel cell system.

For brevity, the detailed structure of the first side frame 216 will not be further described because it is similar the first side frame 216, except that the actual position of through holes and/or mounting slots may be different. As mentioned above, the exact position of through holes is dependent on the particular configuration of the fuel cell system.

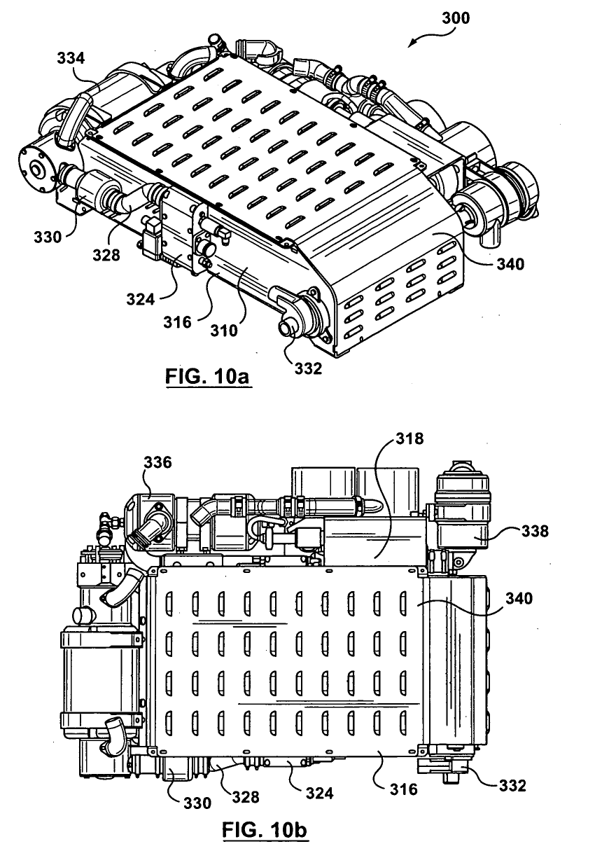

FIGS. 10a and 10b illustrate a fuel cell system 300 having a third embodiment of the main bracket 310 according to the present invention. Similar to the fuel cell system 10 illustrated in FIGS. 1a to 1g, the fuel cell system 300 has fuel cell stacks (not shown) disposed within the main bracket 310 and covered by a cover 340. The main bracket 310 is again comprised of two side frames 316, 318 and two end frames which are covered by the cover 340 and cannot been seen in the figures. A manifold 324 is mounted on a first side frame 316. A tube 328 connects the manifold 324 to a water separator 330 which in turn connects to a cathode humidification unit 334 mounted on one of the end frames of the main bracket 310. The tube 328 extends along an outside face of a first side frame 316. An anode humidification unit 336 is mounted on the outside face of the second side frame 318, and its associated tubes extend along the second side frame 318. A coolant pump 332 is mounted inside of an end frame which is covered by the cover 340. An oxidant blower is mounted outside of the second side frame 318.

It will be understood that, except for the features described below, the side frames 316, 318 and end frames of the main bracket 310 have similar configurations to those in the first and second embodiment. For brevity, the detailed structures will not be described again. From FIGS. 10a and 10b, it can be appreciated that although the fuel cell system 300 has a different configuration from fuel cell system 10 in the first embodiment, the fuel cell stacks may still be located within the main bracket 310 and peripheral devices may be mounted on the outside face the main bracket 310.

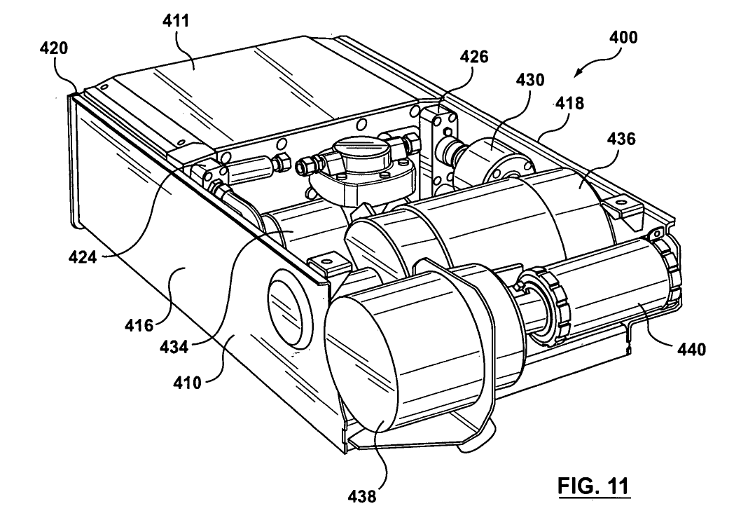

FIG. 11 shows a fuel cell system 400 having a fourth embodiment of the main bracket 410. The main bracket 410 has two side frames 416, 418 and at least one end frame 420. The fuel cell system only has one fuel cell stack 411 enclosed within the main bracket 410. Manifolds 424 and 426 are mounted directly on the fuel cell stack 411. Water separator 430, cathode humidification unit 436, and fuel recirculation pump 434 are all disposed within the main bracket 410. A blower 438 and a filter 440 are respectively mounted on the two side frames 416 and 418. The end of the main bracket 410 opposite to the end where the fuel cell stack 411 is mounted may be open. Alternatively, a second end frame (not shown) may be provided to complete the main bracket 410.

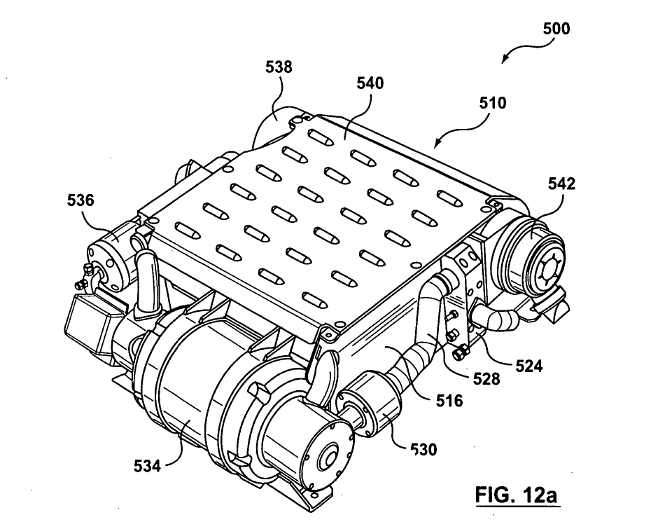

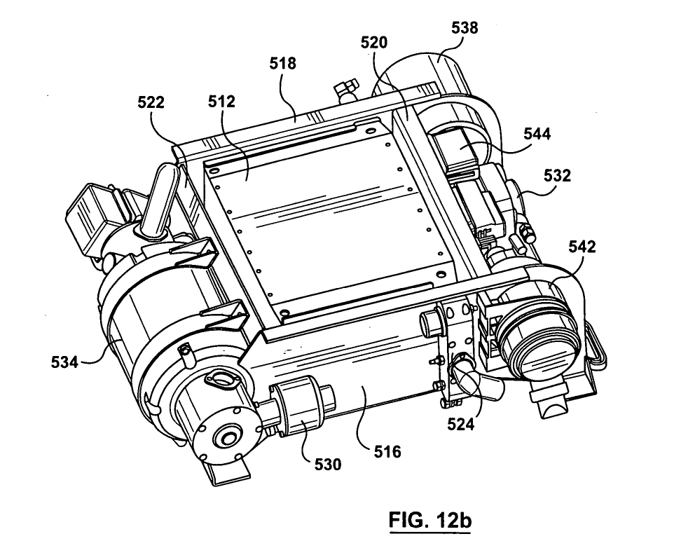

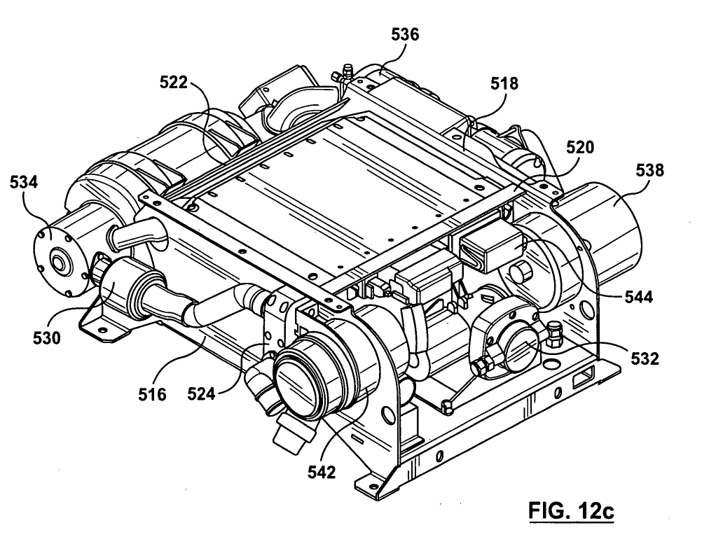

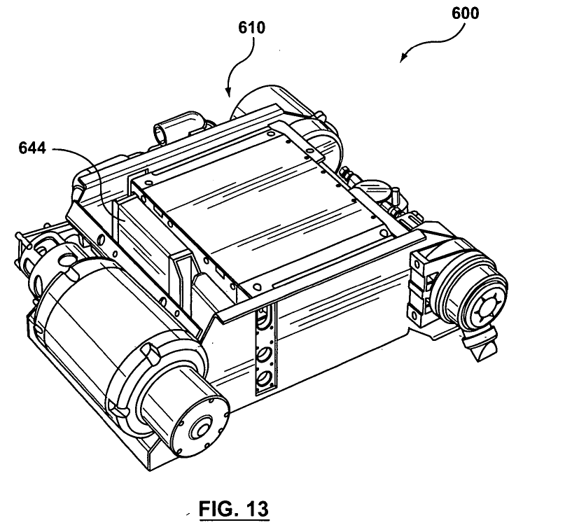

FIGS. 12a to 12c show a fuel cell system 500 having a fifth embodiment of the main bracket 510. The fuel cell system 500 has one fuel cell stack 512 disposed within the main bracket 510 and covered by a cover 540. The main bracket 510 is also generally rectangular in shape and has two side frames 516, 518 and two end frames 520, 522. A manifold 524 is mounted on the outside face of the main bracket 516 and connects to a tub 528 which in turn connects to a water separator 530. The tube 528 extends along the side frame 516. The water separator 530 further communicates with a cathode humidification unit 534 which is mounted on the side frame 522. An anode humidification unit 536 is mounted on the side frame 518. A filter 542, a fuel recirculation pump 532, a blower 538 and electrical control unit 544 are mounted on the end frame 520. As can been seen from the figures, the side frames 516, 518 and end frames 520, 522 have flanges to secure the cover.

FIG. 13 shows a fuel cell system 600 having a sixth embodiment of the main bracket 610. The configuration of the fuel cell system 600 is similar to that in the fifth embodiment (shown in FIGS. 12a to 12c) except that the electrical control unit 644 is disposed inside the main bracket 610. For brevity, the fuel cell system 600 and the main bracket 610 are not described in detail herein.

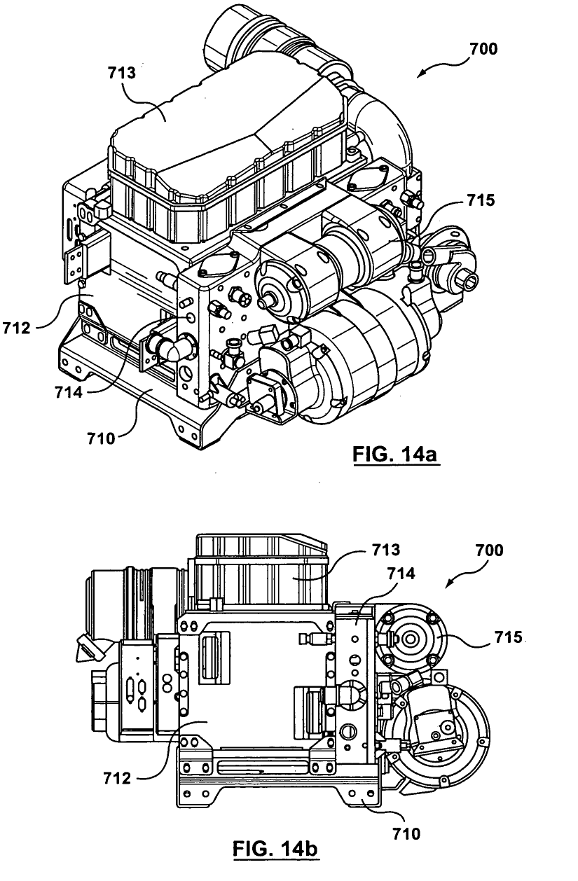

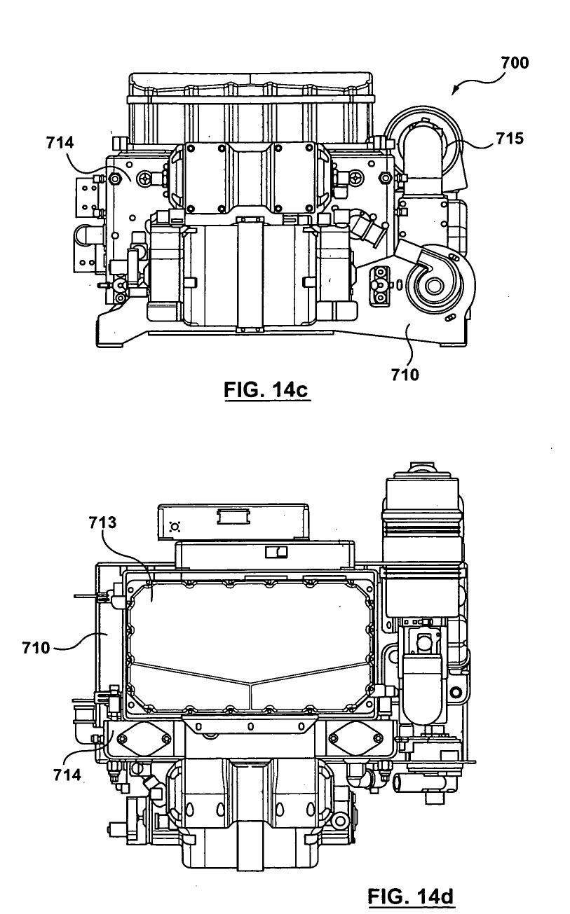

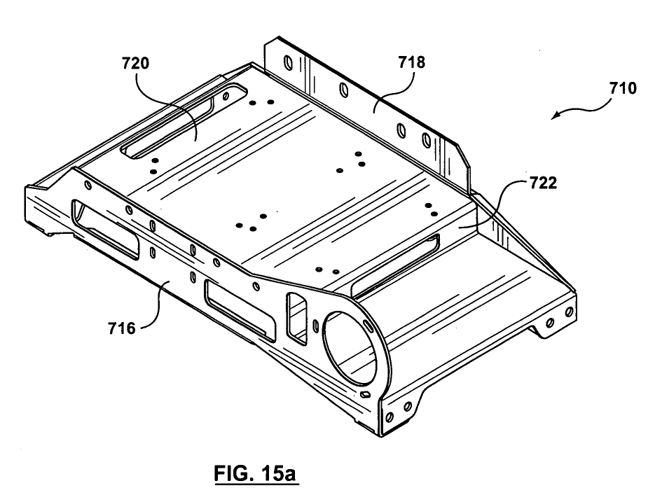

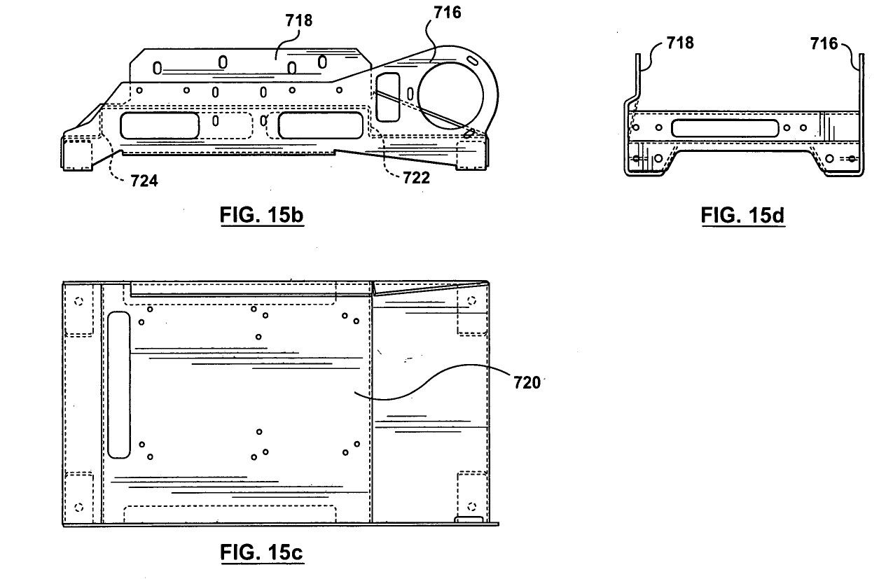

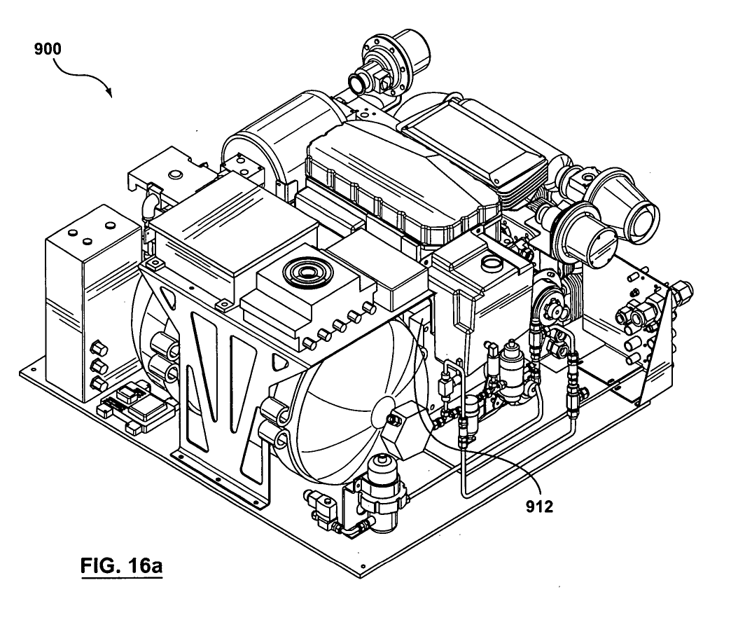

FIGS. 14a to 14d show a fuel cell system 700 having a seventh embodiment of the main bracket 710. FIGS. 15a to 15d show the seventh embodiment of the main bracket 710. In this embodiment, the main bracket 710 consists of two side frames 716, 718 connected to a bottom frame 720 extending between the two side frames. The bottom frame 720 may be planar or may include bent portions 722, 724, as shown in this embodiment. The exact configuration of bottom frame 720 depends on the configurations of the fuel cell peripherals. The bent portions 722 and 724 serve similar function as end frames in the previous embodiments. A fuel cell stack 712 (shown in FIGS. 14a to 14b) is mounted on the bottom frame 720 and a plurality of peripheral devices are mounted on the outside face of side frames 716, 718 of the main bracket 710. Some peripheral devices are mounted on the fuel cell stack, such as a DC-DC converter 713. A manifold plate 714 is attached to the fuel cell stack 712 and mounted on the bottom frame 720. Examples of such manifold plates can be found in U.S. patent application Ser. Nos. 09/900,468 and 10/122,137. Peripheral devices, such as a humidifier 715, may be mounted on the manifold plate 714. In this embodiment, the side frames 716, 718 have less vertical extent than that of the side frames in previous embodiments and some of the fuel cell peripheral devices are not directly mounted on the main bracket 710. It is to be understood that the bottom frame 720 could extend outside of one or both of the side frames 716, 718 as opposed to only between the side frames (as may be desired for particular fuel cell system applications). Other features of the main bracket 710, such as mounting holes, slots, cutout portions serve similar function to those in the previous embodiments and will not be further described in detail.

It should be appreciated that the spirit of the present invention is concerned with providing a main bracket for integration of a fuel cell system. The type and internal structure of the fuel cell stack does not affect the design of the present invention. In other words, the present invention is applicable to various types of fuel cells, electrolyzers or other electrochemical cell systems. The position, number, size and pattern of the fuel cell stacks and peripheral devices are not necessarily identical to that disclosed herein.

It is anticipated that those having ordinary skill in this art can make various modification to the embodiments disclosed herein after learning the teaching of the present invention. Any such modifications should be considered as falling under the protection scope of the invention as defined in the following claims.

1. A bracket for a fuel cell system having at least one fuel cell stack and a plurality of peripheral devices, the bracket comprising:
a) a first side frame; and
b) a second side frame spaced apart from the first side frame, the second side frame being operatively connected to the first side frame;
wherein the first side frame and the second side frame surround at least a portion of the at least one fuel cell stack;
wherein the first and second side frames are adapted for removably mounting the at least one fuel cell stack between the first and second side frames;
wherein the first and second side frames are adapted for removably mounting the plurality of peripheral devices to any face of at least one of the first side frame and the second side frame.

2. The bracket of claim 1, wherein the plurality of peripheral devices are adapted for removably mounting to an outside face of at least one of the first side frame and the second side frame.

3. The bracket of claim 2, wherein at least one of the first side frame and the second side frame defines slots therein, wherein the slots are adapted to permit fluid communication between the peripheral devices and the at least one fuel cell stack.

4. The bracket of claim 3, wherein at least one of the first and second side frames defines through holes therein to permit removable mounting of the peripheral devices an outside face thereof.

5. The bracket of claim 4, further comprising at least one end frame connecting the first and second side frames, wherein the at least one end frame and the first and second side frames surround the portion of the at least one fuel cell stack, wherein the at least one end frame is adapted for removably mounting a portion of the plurality of peripheral devices thereon.

6. The bracket of claim 5, further comprising a first end frame and a second end frame spaced apart from the first end frame and in opposing relation thereto, wherein the first and second side frames and the first and second end frames form a rectangular shape, wherein the first and second side frames and the first and second end frames surround the portion of the at least one fuel cell stack.

7. The bracket of claim 6, wherein the at least one fuel cell stack defines four sides, wherein the first and second side frames and the first and second end frames surround the four sides of the at least one fuel cell stack.

8. The bracket of claim 6, wherein the first and second side frames are connected to the first and second end frames by tenon joints.

9. The bracket of claim 8, wherein the first and second side frames each define:
a) a central portion located between the first and second end frames; and
b) a first end portion and a second end portion located outside the first and second end frames.

10. The bracket of claim 9, wherein the first and second side frame each comprise a bottom flange adapted for removable mounting of the at least one fuel cell stack thereon, the bottom flange being connected to the central portion.

11. The bracket of claim 10, wherein the first and second side frame each comprise a top flange adapted for removable mounting of a cover thereon, the top flange being connected to the central portion.

12. The bracket of claim 11, wherein the first and second end frames each comprise a substantially vertical portion and a substantially horizontal portion, the substantially vertical and horizontal portions defining a plurality of openings therein for removably mounting the peripheral devices.

13. The bracket of claim 12, wherein the first and second end frames each comprise an upper end flange connected to the substantially vertical portion and a lower end flange connected to the substantially horizontal portion, the upper end flange being adapted for removably mounting the cover thereto, the lower end flange being adapted to mount the bracket to an intended location.

14. The bracket of claim 9, wherein the second end portion defines a concave portion adapted to accommodate one of the plurality of peripheral devices, wherein the one of the plurality of peripheral devices protrudes from the first side frame.

15. The bracket of claim 9, wherein the first end portion defines a mounting slot proximate to a top end thereof, the mounting slot being adapted to engage a tenon connected to the first end frame, wherein said tenon and said mounting slot cooperate to form a tenon joint.

16. The bracket of claim 15, wherein each of the side frames and the end frames is integrally constructed from a single piece of material.

17. The bracket of claim 2, wherein the at least one fuel cell stack comprises a first and second fuel cell stack, the first side frame defining a first slot and a second slot proximate to said first slot, the first and second slots being located proximate to adjoining ends of the first and second fuel cell stacks, the first and second slots being adapted to removably receive a manifold, the manifold adapted for fluid communication with the first and second fuel cell stack.

18. The bracket of claim 1 further comprising a bottom frame connecting the first and second side frames, wherein the bottom frame is adapted to removably secure the at least one fuel cell stack thereon.

19. The bracket of claim 18, wherein the bottom frame extends beyond an outside face of the first side frame.

20. An electrochemical cell system comprising:
a) at least one fuel cell stack;
b) a plurality of peripheral devices operatively connected to the at least one fuel cell stack; and
c) a bracket surrounding at least a portion of the at least one fuel cell stack, the bracket being adapted for removably mounting the at least one fuel cell stack therein, the bracket being adapted for removably mounting the plurality of peripheral devices to an outside face thereof.

21. The system of claim 20, wherein the bracket comprises:
a) a first side frame; and
b) a second side frame spaced apart from the first side frame, the second side frame being operatively connected to the first side frame;
wherein the first side frame and the second side frame surround at least a portion of the at least one fuel cell stack;
wherein the first and second side frames are adapted for removably mounting the at least one fuel cell stack between the first and second side frames;
wherein the first and second side frames are adapted for removably mounting the plurality of peripheral devices to an outside face of at least one of the first side frame and the second side frame.

22. The system of claim 21, wherein at least one of the first side frame and the second side frame defines slots therein, wherein the slots are adapted to permit fluid communication between the peripheral devices and the at least one fuel cell stack.

23. The system of claim 22, wherein at least one of the first and second side frames defines through holes therein to permit removable mounting of the peripheral devices an outside face thereof.

24. The system of claim 23, wherein the bracket comprises at least one end frame connecting the first and second side frames, wherein the end frame and the first and second side frames surround the portion of the at least one fuel cell stack, wherein the at least one end frame is adapted for removably mounting a portion of the plurality of peripheral devices thereon.

25. The system of claim 24, wherein the bracket comprises a first end frame and a second end frame spaced apart from the first end frame and in opposing relation thereto, wherein the first and second side frames and the first and second end frames form a rectangular shape, wherein the first and second side frames and the first and second end frames surround the portion of the at least one fuel cell stack.

26. The system of claim 25, wherein the at least one fuel cell stack defines four sides, wherein the first and second side frames and the first and second end frames surround the four sides of the at least one fuel cell stack.

27. The system of claim 25, wherein the first and second side frames are connected to the first and second end frames by tenon joints.

28. The system of claim 25, wherein the first and second side frames each define:
a) a central portion located, between the first and second end frames; and
b) a first end portion and a second end portion located outside the first and second end frames.

29. The system of claim 28, wherein the first and second side frame each comprise a bottom flange adapted for removable mounting of the at least one fuel cell stack thereon, the bottom flange being connected to the central portion.

30. The system of claim 29, wherein the first and second side frame each comprise a top flange adapted for removable mounting of a cover thereon, the top flange being connected to the central portion.

31. The system of claim 30, wherein the first and second end frames each comprise a substantially vertical portion and a substantially horizontal portion, the substantially vertical and horizontal portions defining a plurality of openings therein for removably mounting the peripheral devices.

32. The system of claim 31, wherein the first and second end frames each comprise an upper end flange connected to the substantially vertical portion and a lower end flange connected to the substantially horizontal portion, the upper end flange being adapted for removably mounting the cover thereto, the lower end flange being adapted to mount the bracket to an intended location.

33. The system of claim 28, wherein the second end portion defines a concave portion adapted to accommodate one of the plurality of peripheral devices, wherein the one of the plurality of peripheral devices protrudes from the first side frame.

34. The system of claim 28, wherein the first end portion defines a mounting slot proximate to a top end thereof, the mounting slot being adapted to engage a tenon connected to the first end frame, wherein said tenon and said mounting slot cooperate to form a tenon joint.

35. The system of claim 34, wherein each of the side frames and the end frames is integrally constructed from a single piece of material.

36. The system of claim 21, wherein the at least one fuel cell stack comprises a first and second fuel cell stack, the first side frame defining a first slot and a second slot proximate to said first slot, the first and second slots being located proximate to adjoining ends of the first and second fuel cell stacks, the first and second slots being adapted to removably receive a manifold, the manifold adapted for fluid communication with the first and second fuel cell stack.

37. The system of claim 21, wherein the bracket further comprises a bottom frame connecting the first and second side frames, wherein the bottom frame is adapted to removably secure the at least one fuel cell stack thereon.

38. The system of claim 37, wherein the bottom frame extends beyond an outside face of the first side frame.
